(19) United States
(12) Patent Application Publication
(10) Pub. No.: US 2005/0071191 A1
(43) Pub. Date: Mar. 31, 2005

(54) Methods of dispensing generic pharmaceutical products

(76) Inventors: Rodney Gerard Wilson, St. Louis, MO (US); Sean Michael Walsh, O'Fallon, MO (US); Bonnie Deane Roberts, Chesterfield, MO (US); Becky Coffman, St. Louis, MO (US)

Correspondence Address: James B. Surber;One Metropolitan Square, Suite 3600, 211 North Broadway, St. Louis, MO, 63102, US

(21) Appl. No.: 10/674,582

(22) Filed: Sep. 29, 2003

(51) Int. Cl. G06F 17/60

(52) U.S. Cl. 705/2

(57) ABSTRACT

The present invention relates to methods of dispensing generic pharmaceutical products to qualified patients, physicians and/or pharmacies. In one embodiment, the methods generally involve a plurality of sources of generic pharmaceutical products transferring generic pharmaceutical products to one or more charitable foundations. The one or more charitable foundations further transfer the generic pharmaceutical products to a centralized sourcing agent and distributor. Alternatively, the sources of generic pharmaceutical products may transfer the same directly to the centralized sourcing agent and distributor. The centralized sourcing agent and distributor compiles information provided by a plurality of patients; using this information and substantially universal criteria, the centralized sourcing agent and distributor identifies patients that are qualified to purchase the received generic pharmaceutical products at reduced prices; and dispenses the received generic pharmaceutical products to qualified patients at their request and in accordance with their prescription. Alternatively, the centralized sourcing agent and distributor may dispense the received generic pharmaceutical products directly to physicians or to pharmacies for future distribution to appropriate patients. Still further, the centralized sourcing agent and distributor may dispense generic pharmaceutical products, which it receives directly from pharmaceutical manufacturers, wholesalers or other sources, to one or more charitable foundations. The one or more charitable foundations may then dispense the appropriate generic pharmaceutical products to qualifying patients, physicians and/or pharmacies.

### FIELD OF THE INVENTION

The present invention relates to methods of dispensing pharmaceutical products. In particular, the present invention relates to methods of dispensing generic pharmaceutical products.

### BACKGROUND OF THE INVENTION

It is well-known that prescription pharmaceuticals are often prohibitively expensive for certain groups of patients. Such groups of patients generally include individuals whose income level is insufficient, or is otherwise strained, to cover the cost of needed prescription pharmaceuticals and the costs associated with the provision of other basic necessities, such as housing, food, clothing and other items needed to sustain an acceptable quality of life.

To further complicate matters, prices of prescription pharmaceuticals are rising at considerable rates. Indeed, at least in recent years, the annualized price increase for prescription pharmaceuticals, on average, has significantly exceeded standard inflationary rates. Against this background, most civilized countries today seek to ensure that all persons—regardless of economic status—have access to necessary medications.

The availability of generic pharmaceuticals has, in part, provided economically-challenged patients with access to needed medicine. In most cases, generic pharmaceuticals can be purchased at substantially reduced prices when measured against comparable “brand-name” pharmaceuticals. The availability of generic pharmaceuticals, however, has not completely rendered such medication accessible to all. Indeed, there is still a growing population who cannot afford even lower cost medications. In light of the foregoing, there is still a substantial need for further methods of lowering the costs of even generic pharmaceutical products for those who are economically challenged.

Some pharmaceutical manufacturers have taken measures to lower the cost of “brand-name” pharmaceutical products for certain patients. In particular, several manufacturers have implemented programs that allow economically-challenged patients to purchase “brand-name” pharmaceuticals at substantially reduced prices. Despite their altruistic intent, these programs often absorb significant time and administrative resources of participating patients, patient advocate groups and physicians. The underlying cause of the corresponding administrative burden relates to the means by which these programs are managed.

Specifically, with a few minor exceptions, each pharmaceutical manufacturer has typically set its own criteria that governs whether a patient may qualify for its program, and thus, be allowed to purchase its “brand-name” pharmaceutical products at reduced prices. Thus, the criteria that patients must satisfy in order to qualify for any given program offered by any of several pharmaceutical manufacturers vary. For this reason, patients, patient advocate groups and physicians endure considerable time and administrative costs in applying for each unique program. Although some pharmaceutical manufacturers have taken measures to lower the cost of “brand-name” pharmaceutical products for certain patients, the same cannot be said with respect to generic pharmaceutical products. That is, generic pharmaceutical manufacturers, to date, have not offered any types of similar programs for generic pharmaceutical products to economically-challenged patients.

In light of the foregoing, it would be desirable to provide new methods of dispensing generic pharmaceutical products to qualified patients at reduced prices. More importantly, it would be desirable to provide methods of dispensing generic pharmaceutical products to qualified patients at reduced prices, wherein the criteria that are applied to determine whether any given patient is qualified to receive such products are universal across a plurality of generic pharmaceutical products and corresponding manufacturers.

### SUMMARY OF THE INVENTION

The present invention relates to methods of dispensing generic pharmaceutical products to a plurality of patients, physicians and/or pharmacies. In one embodiment, a plurality of sources of generic pharmaceutical products transfer, either by sale or donation, generic pharmaceutical products to one or more charitable foundations. The sources of generic pharmaceutical products that transfer the same by way of donation may, in accordance with such laws that may be applicable at the time of each donation, and in the corresponding jurisdiction, be allowed to exercise a tax deduction, tax credit or receive any other tax benefit as a result of its charitable donation. The transferred generic pharmaceutical products consist of products that the plurality of sources are willing to sell or donate to one or more charitable foundations for any reason. The transferred generic pharmaceutical products may include, but are not limited to, pharmaceuticals which are short-dated, returned products, or which the manufacturer has excess stock or capacity to manufacture.

In accordance with one embodiment of the present invention, once the generic pharmaceutical products have been donated or sold to the receiving charitable foundations, the foundations may then preferably transfer the products to a centralized sourcing agent and distributor. Alternatively, a plurality of sources of generic pharmaceutical products may preferably sell or donate generic pharmaceutical products directly to a centralized sourcing agent and distributor, and bypass the intermittent charitable foundation.

The centralized sourcing agent and distributor preferably compiles information provided by a plurality of patients, wherein such information can be used to assess each patient's financial condition, insurance coverage and/or other factors that may be relevant to their ability to purchase prescription pharmaceuticals. The centralized sourcing agent and distributor preferably uses this information in connection with standardized criteria to determine whether each patient is qualified to receive donated generic pharmaceutical products at reduced prices.

The centralized sourcing agent and distributor may also compile information regarding the relative demand for specific generic pharmaceutical products among a plurality of economically-challenged patients. Using this information, the centralized sourcing agent and distributor may develop forecasts and identify one or more sources of generic pharmaceutical products that are willing to sell or donate generic pharmaceutical products to meet current and/or expected demand among economically-challenged patients for specific generic pharmaceutical products.

The centralized sourcing agent and distributor may, preferably, further compile information related to a specific pharmacy or prescribing physician to which the centralized sourcing agent and distributor may also dispense generic pharmaceutical products. Still further, the centralized sourcing agent and distributor may compile information related to the prescription under which each patient is authorized to purchase a specific generic pharmaceutical product.

If the centralized sourcing agent and distributor determines that a patient is qualified, it can preferably dispense the appropriate generic pharmaceutical product to the patient in accordance with the physician's prescription. Alternatively, the centralized sourcing agent and distributor may dispense the appropriate generic pharmaceutical product to the prescribing physician, or to any pharmacy. The centralized sourcing agent and distributor can preferably dispense a plurality of the generic pharmaceutical products to qualifying patients, physicians or pharmacies by way of sale at reduced prices, or, alternatively, at little or no cost.

Still further, the centralized sourcing agent and distributor can transfer generic pharmaceutical products that it receives directly from a plurality of sources to one or more charitable foundations. In this case, the one or more charitable foundations can further transfer the appropriate generic pharmaceutical products to qualified patients, physicians and/or pharmacies.

### BRIEF DESCRIPTION OF THE FIGURES

FIG. 1: A schematic diagram of one of the preferred embodiments of the invention described herein, which involves one or more charitable foundations receiving generic pharmaceutical products directly from pharmaceutical manufacturers and/or wholesalers.

FIG. 2: A schematic diagram of one of the preferred embodiments of the invention described herein, which does not involve one or more charitable foundations.

FIG. 3: A schematic diagram of one of the preferred embodiments of the invention described herein, which involves one or more charitable foundations receiving generic pharmaceutical products directly from the centralized sourcing agent and distributor.

FIG. 4: A schematic diagram of one of the preferred embodiments of the invention described herein, which involves the centralized sourcing agent and distributor receiving generic pharmaceutical products from one or more charitable foundations, and the centralized sourcing agent and distributor transferring such products to one or more pharmacies.

FIG. 5: A schematic diagram of one of the preferred embodiments of the invention described herein, which involves the centralized sourcing agent and distributor receiving generic pharmaceutical products directly from a plurality of sources, and the centralized sourcing agent and distributor transferring such products to one or more pharmacies.

### DETAILED DESCRIPTION OF THE INVENTION

The following will describe in detail several preferred embodiments of the invention. These embodiments are provided by way of explanation only, and thus, should not unduly restrict the scope of the invention. In fact, those of ordinary skill in the art will appreciate upon reading the present specification and viewing the present drawings that many variations and modifications of the invention may be employed, used and made without departing from the scope and spirit of the invention.

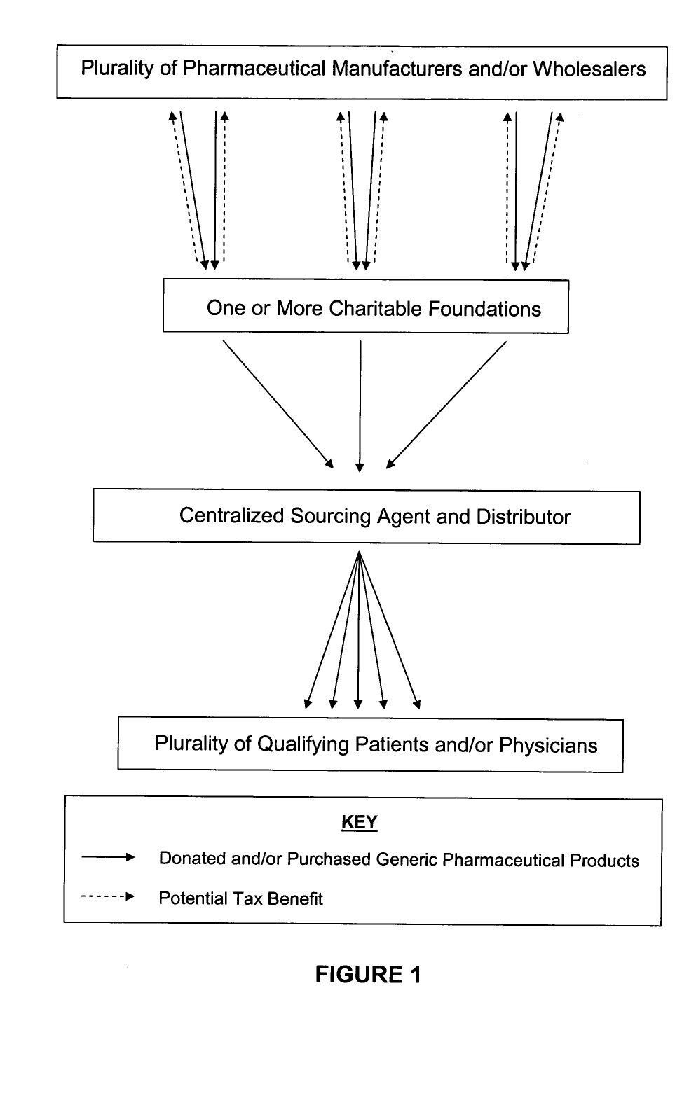

FIGS. 1-5 present general outlines of certain preferred embodiments described herein, and may serve as a useful reference when reviewing the following description of the present invention. In a first preferred embodiment, one or more sources of generic pharmaceutical products transfer generic pharmaceutical products to one or more charitable foundations. The one or more sources of generic pharmaceutical products include, for example, pharmaceutical manufacturers and/or pharmaceutical wholesalers. Furthermore, the one or more sources of generic pharmaceutical products may transfer such products to one or more charitable foundations including, for example, by donation or sale. If generic pharmaceutical products are transferred by way of donation, in accordance with applicable tax laws at the time of each donation, each source of generic pharmaceutical product may be allowed to exercise certain tax deductions, credits, or similar incentives, in recognition of its charitable donation.

In general, a tax deduction or credit will permit the entity donating pharmaceuticals, such as a pharmaceutical manufacturer, to reduce its taxable income or otherwise reduce its tax liability as a result of a corresponding donation of generic pharmaceutical products to one or more charitable foundations. Several factors may be relevant to whether a pharmaceutical manufacturer, or other donating entity or person, would be allowed to claim a tax credit or deduction, for example, in recognition of any given charitable donation of generic pharmaceutical products. In assessing whether the entity making the donation will be entitled to a tax deduction or credit, and the amount, if any, of such a deduction or credit, the donating entity should review applicable tax laws in effect at the time of such proposed donation and, of course, confer with a qualified tax advisor. An example of applicable federal tax laws may be found in the Internal Revenue Code (“IRC”) of the United States—as applied in the year 2003. In particular, IRC §170(e)(3) (2003) governs the circumstances under which pharmaceutical manufacturers may be allowed to claim a tax deduction in recognition of a charitable donation of inventory. TITLE 26, SUBTITLE A, CHAPTER 1, SUBCHAPTER B, PART VI, SEC. 170.

Furthermore, a qualified tax advisor should be consulted when determining whether a particular foundation is able to receive tax-deductible contributions, including contributions of generic pharmaceutical products. The criteria that must be satisfied for any given organization to be considered eligible to receive tax-deductible contributions may vary over time to reflect changes to the applicable tax laws. A non-limiting example of such criteria may be found in IRC §501 (C)(3) (2003). TITLE 26, SUBTITLE A, CHAPTER 1, SUBCHAPTER F, PART I, SEC. 501. Organizations that satisfy the criteria set forth in this section are capable of receiving tax-deductible contributions in accordance with §170 of that same Code. Such organizations may be private foundations, public charities or any other entity that satisfies the criteria set forth in IRC §501 (C)(3).

The transfer of generic pharmaceutical products either, for example, by sale or donation, does not require that the physical products themselves be transferred to one or more charitable foundations. Rather, the transfer may be consummated through any of numerous legal means such as, for example, that provide each receiving charitable foundation with the right to control the received generic pharmaceutical products. Specifically, as understood according to present laws, a transfer may be deemed to occur when a receiving charitable foundation acquires the right to further transfer the received generic pharmaceutical products, directly or indirectly, to the centralized sourcing agent and distributor.

For example, a pharmaceutical manufacturer may decide, in accordance with one embodiment of the present invention, to donate certain generic pharmaceutical products to one or more charitable foundations. In accordance with the instructions of the one or more charitable foundations, the donated generic pharmaceutical products may preferably be transferred to: (i) a facility owned and/or managed by the one or more charitable foundations, (ii) a third-party that is subject to the control of the one or more charitable foundations, (iii) a centralized sourcing agent and distributor, or (iv) the one or more charitable foundations may elect to store the donated generic pharmaceutical products at the facilities of the donating manufacturer (or its distributor) until further action is taken to transfer the products to a third party such as, for example, a centralized sourcing agent and distributor.

Generic pharmaceutical products, in accordance with the present invention, can be transferred, sold or donated to one or more charitable foundations for any underlying reason, namely, economic, charitable, business-related, strategic, etc. In some cases, pharmaceutical manufacturers may be inclined to donate short-dated or returned products. Short-dated pharmaceutical products, generally, include products that have a shortened useful life. Non-limiting examples of short-dated products include, for example, generic pharmaceutical products that are set to expire within 60 days, or within 60-180 days, or within 180-365 days. Returned pharmaceutical products, generally, include products that have been returned, for example to the appropriate pharmaceutical manufacturer (or its distributor), because such products were ultimately not distributed to patients, or used by patients for which the products were originally prescribed and/or dispensed, or because the products were never dispensed by the receiving physician or pharmacy or never distributed by the wholesaler.

Because short-dated and returned pharmaceutical products are often destroyed and never sold, pharmaceutical manufacturers, wholesalers or any other source of generic pharmaceutical products would reap many benefits from making such donations of generic pharmaceutical products to one or more charitable foundations that would otherwise be lost. In particular, these entities may benefit from a tax deduction, tax credit or any other tax incentive under the current tax laws. In addition, entities that make charitable donations of generic pharmaceuticals may benefit from a favorable perception by the consuming public. These benefits are particularly attractive when the donated generic pharmaceutical products would otherwise be destroyed.

Once the generic pharmaceutical products have been transferred, the receiving charitable foundations may then, in accordance with one embodiment of the present invention, further transfer the products to a centralized sourcing agent and distributor. The transfer of generic pharmaceutical products from one or more charitable foundations to a centralized sourcing agent and distributor may occur in several different ways. For example, the generic pharmaceutical products may preferably be physically transferred to a facility owned and/or managed by the centralized sourcing agent and distributor. Alternatively, the generic pharmaceutical products can be physically transferred to a facility owned and/or managed by another third-party, which is subject to the control of the centralized sourcing agent and distributor. In short, the transfer may occur in any way that allows the centralized sourcing agent and distributor to move the received generic pharmaceutical products downstream to qualified patients, at its own will, directly or indirectly.

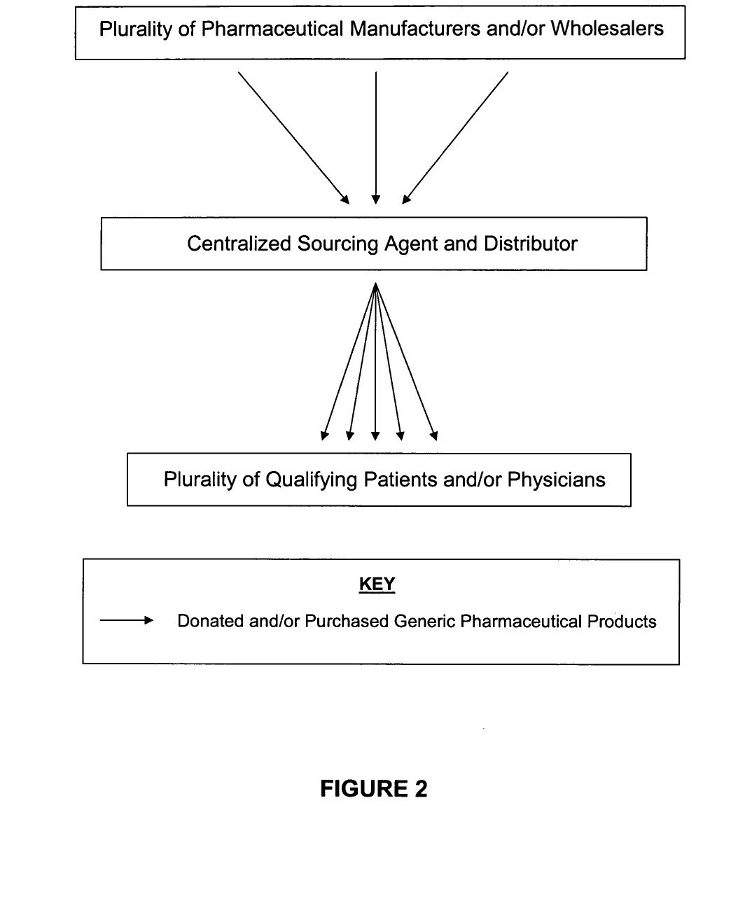

In a second embodiment, as illustrated in FIG. 2, a plurality of sources of generic pharmaceutical products preferably transfer generic pharmaceutical products directly to a centralized sourcing agent and distributor. The transfer of generic pharmaceutical products may occur by way of, for example, sale or donation. The sources of generic pharmaceutical products may elect to bypass the one or more charitable foundations for any of numerous reasons as will be understood to those of ordinary skill in the art.

For example, a pharmaceutical manufacturer's financial position and/or tax status, or the applicable tax laws, may preclude it from claiming a tax credit or deduction for donating generic pharmaceutical products to a charitable foundation. The pharmaceutical manufacturer may nonetheless desire to donate generic pharmaceutical products to the centralized sourcing agent and distributor - even without receiving the benefit of a tax credit or deduction—for other reasons, such as consumer goodwill, or philanthropic reasons. In such case, it may be more efficient to simply donate the generic pharmaceutical products directly to the centralized sourcing agent and distributor. In sum, the methods of the present invention do not require that the plurality of sources of generic pharmaceutical products transfer generic pharmaceutical products to a charitable foundation, nor do the methods require that donating sources benefit from a corresponding tax deduction or tax credit.

The centralized sourcing agent and distributor is, preferably, responsible for continuously compiling information provided by a plurality of patients, prescribing physicians and/or pharmacies. This information is preferably compiled for several reasons. First, the centralized sourcing agent and distributor may compile such information to determine whether each patient who desires to purchase the received generic pharmaceutical products at reduced prices is qualified. The centralized sourcing agent and distributor may also compile information that is needed to identify each patient, and record his/her shipping address for when, and if, medication is eventually dispensed to each patient. In light of the foregoing, the centralized sourcing agent and distributor may compile information that is provided by a plurality of patients, wherein such information may include each patient's full name, social security number, primary address, preferred shipping address, phone number, age or date of birth, gender, marital status, employment status, annual gross income, annual taxable income, the number of dependents for which each patient is responsible as defined by current tax laws, and/or the amount, if any, of private and/or public medical insurance that each patient may draw upon.

In addition, the centralized sourcing agent and distributor may compile information related to the physician's prescription under which each patient is authorized to purchase a specific generic pharmaceutical product, which may be provided by the patient and/or the prescribing physician. Such information may include appropriate identifiers for the generic pharmaceutical product prescribed, the dosage amount, the dosage frequency, safety information, expiration date(s), storage information and/or a description of the medical affliction for which the generic pharmaceutical product has been prescribed.

Because the centralized sourcing agent and distributor may also elect to transfer generic pharmaceutical products directly to prescribing physicians and/or to any pharmacy, the centralized sourcing agent and distributor may compile information related to and provided by such physicians and pharmacies. Information related to prescribing physicians may include each physician's full name, business address, business telephone number, DEA number, i.e., the registration number issued by the U.S. Drug Enforcement Agency to prescribing physicians, other appropriate medical licensure information and/or information related to the medical facility by which each physician is employed. Likewise, the centralized sourcing agent and distributor may compile appropriate information related to specific pharmacies to which it intends to transfer generic pharmaceutical products.

In addition to the information described above, the centralized sourcing agent and distributor may compile information regarding the relative demand for specific generic pharmaceutical products among a plurality of economically-challenged patients. Using this information, the centralized sourcing agent and distributor may be able to forecast and identify one or more sources of generic pharmaceutical products that are willing to sell or donate generic pharmaceutical products to meet current and/or expected demand among economically-challenged patients for specific generic pharmaceutical products. Thus, the centralized sourcing agent and distributor, under the present invention, may be responsible for continuously assessing the demand for specific generic pharmaceutical products among economically-challenged patients and identifying sources of generic products to meet such demand.

The centralized sourcing agent and distributor may compile the previously-described information in many ways known in the art. For example, the information can be summoned by having patients and/or physicians who are interested in receiving donated generic pharmaceutical products enter the appropriate information into paper forms that can be returned to the centralized sourcing agent and distributor by mail or facsimile. The centralized sourcing agent and distributor could then review the information presented in the forms and/or enter the information into a computer readable format. Alternatively, the centralized sourcing agent and distributor could access information from a patient's insurance carrier, or other entity, that is authorized to share such information with the centralized sourcing agent and distributor, i.e., authorized by law or pursuant to a patient's consent. Still further, the centralized sourcing agent and distributor could publish interactive, computer readable forms on the internet, whereby patients and/or physicians who are interested in receiving generic pharmaceutical products could enter the requested information into the forms, and submit the information electronically via the internet, or by electronic mail, to the centralized sourcing agent and distributor.

The centralized sourcing agent and distributor may, under the present invention, require physicians to certify that prescriptions for generic pharmaceutical products are issued for medical purposes only and/or make other representations that may be appropriate under the circumstances. This certification can be memorialized in any of several ways known in the art, such as having the prescribing physician place his/her signature on a document that sets forth the appropriate certification and submitting the same to the centralized sourcing agent and distributor. Current technology may also allow prescribing physicians to submit an appropriate certification electronically, such as by having the prescribing physician sign (electronically) an interactive form that is available over the internet and submitting the same to the centralized sourcing agent and distributor. There are various, well-known methods in the art by which parties can place an electronic signature on a document that is viewed over the internet.

Based on the information provided by patients, physicians and/or pharmacies, the centralized sourcing agent and distributor may identify patients who are qualified to purchase the generic pharmaceutical products that it has received (either through sale or donation) at reduced prices. The criteria that the centralized sourcing agent and distributor uses to determine whether each patient is qualified to receive such generic pharmaceutical products are, preferably, universal across a plurality of received generic pharmaceutical products and corresponding sources of such products. The degree to which these criteria are universal or standardized, however, is not inflexible. For example, the centralized sourcing agent and distributor under the present invention may apply a unique set of criteria for a certain age group, income level, or for patients who have some modicum of medical insurance coverage. Of course, these examples are provided for purposes of illustration only, and in no way limit the possible categories of criteria that a centralized sourcing agent and distributor may employ. In short, different sets of universal or standardized criteria may be created for one or more categories of patients. This notwithstanding, the universal criteria that the centralized sourcing agent and distributor employs will, generally, harmonize the requirements that must be satisfied for any given patient to purchase the received generic pharmaceutical products at reduced prices, which may originate from any of a multitude of sources.

The criteria may further be designed to minimize the effort and expense that the centralized sourcing agent and distributor must expend to determine whether each patient is qualified. For example, the criteria may simply incorporate standards based upon the recognized Federal Poverty Level. By way of illustration only, the following provides three universal criterion that the centralized sourcing agent and distributor may apply to determine whether each patient is qualified:
1. The patient must reside in the United States;
2. The patient must not have access to any prescription drug benefits or insurance coverage; and
3. The patient's household income must be equal to or less than 200% of the Federal Poverty Level.
   In short, the centralized sourcing agent and distributor of the present invention can fashion the criteria that it will use to identify qualified patients in any way that it desires. What's important, however, is that such criteria may, generally, be applied consistently across a plurality of generic pharmaceutical products that are sold or donated by a multitude of sources.

Furthermore, the universal criteria used to determine whether patients are qualified to receive such generic pharmaceutical products may vary over time. In particular, such criteria may be modified from time to time in order to reflect changes in cost of living, the particular needs for any given patient-type, and any other relevant factors.

If the centralized sourcing agent and distributor determines that a patient is qualified and, therefore, eligible to purchase the received generic pharmaceutical products at reduced prices, it can dispense the appropriate product to the qualified patient—in accordance with a physician's prescription. Of course, the centralized sourcing agent and distributor can preferably dispense a plurality of such generic pharmaceutical products to qualifying patients by way of sale at reduced prices. The price attributed to any given generic pharmaceutical product, however, is preferably left to the discretion of the centralized sourcing agent and distributor.

The centralized sourcing agent and distributor, for example, may preferably recoup the costs (fixed and variable) that it incurs in connection with the entire transaction—from receiving the generic pharmaceutical products to dispensing the same to the end user. In addition, the centralized sourcing agent and distributor may recoup any costs incurred by any charitable foundation that received generic pharmaceutical products in connection with the transaction. The costs incurred by any charitable foundation may be reimbursed by the centralized sourcing agent and distributor at any time. The centralized sourcing agent and distributor, for example, may reimburse a charitable foundation upon receipt of generic pharmaceutical products, upon receipt of payment by qualified patients, physicians or pharmacies, or at any other time agreed to by the centralized sourcing agent and distributor and charitable foundation. Alternatively, the centralized sourcing agent and distributor may dispense the received generic pharmaceutical products to qualifying patients at little or no cost.

As mentioned above, the centralized sourcing agent and distributor of the present invention may also dispense the received generic pharmaceutical products directly to prescribing physicians or to pharmacies at reduced prices. Here again, the price attributed to any particular generic pharmaceutical product is left to the discretion of the centralized sourcing agent and distributor. The centralized sourcing agent and distributor may receive payment for such generic pharmaceutical products in accordance with any schedule that is agreed to by the parties.

The centralized sourcing agent and distributor can transfer the received generic pharmaceutical products to qualified patients, physicians and/or pharmacies using any method known in the art. For example, using the information provided by each patient as described above, namely each patient's preferred shipping address, the centralized sourcing agent and distributor may fill prescriptions for qualified patients with the appropriate generic pharmaceutical product using standard mail order practices. Alternatively, the centralized sourcing agent and distributor may transfer generic pharmaceutical products to prescribing physicians or to pharmacies for future distribution to appropriate patients.

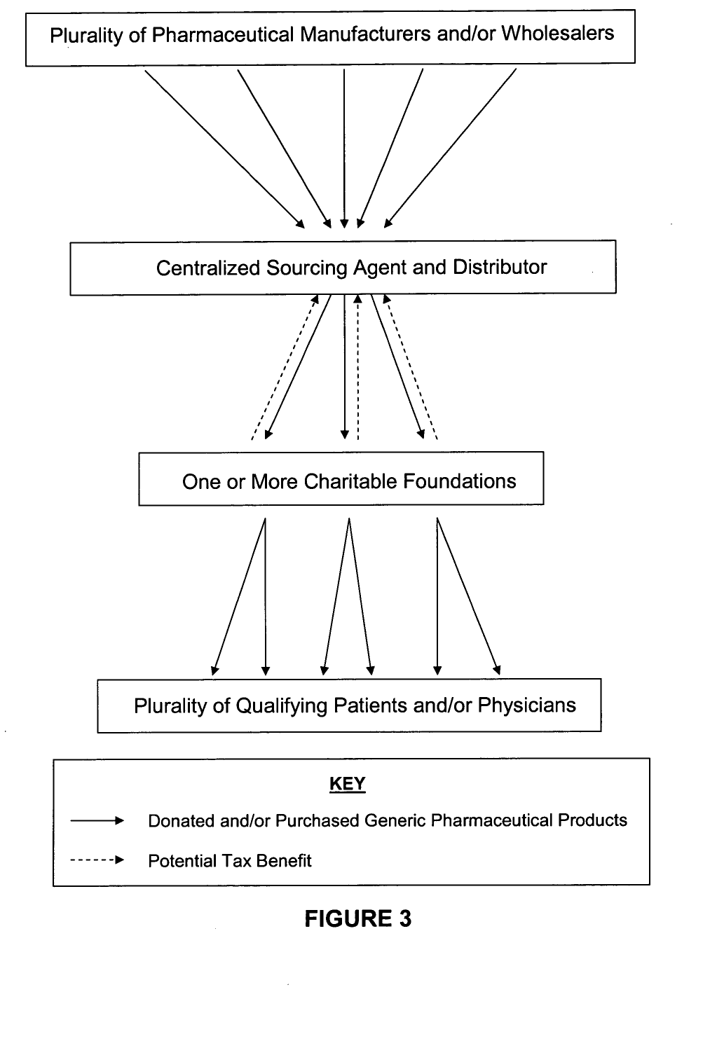

In a third embodiment, as shown in FIG. 3, a centralized sourcing agent and distributor preferably receives one or more generic pharmaceutical products from a plurality of sources. Here again, the transfer of generic pharmaceutical products from the plurality of sources to the centralized sourcing agent and distributor may occur by any number of ways including, for example, by sale or donation—as described above. The centralized sourcing agent and distributor may be responsible for compiling information provided by a plurality of patients. As described earlier, using this information and substantially universal criteria, the centralized sourcing agent and distributor may identify patients who are qualified to purchase the received generic pharmaceutical products at reduced prices. The centralized sourcing agent and distributor then may, preferably, transfer the received generic pharmaceutical products to one or more charitable foundations by way of sale or donation. The one or more charitable foundations may then further dispense the generic pharmaceutical products to qualified patients, physicians and/or pharmacies in accordance with the methods described above. If the centralized sourcing agent and distributor transfers the received generic pharmaceutical products to the one or more charitable foundations by way of donation, of course, it may be entitled to a tax deduction or tax credit as described above.

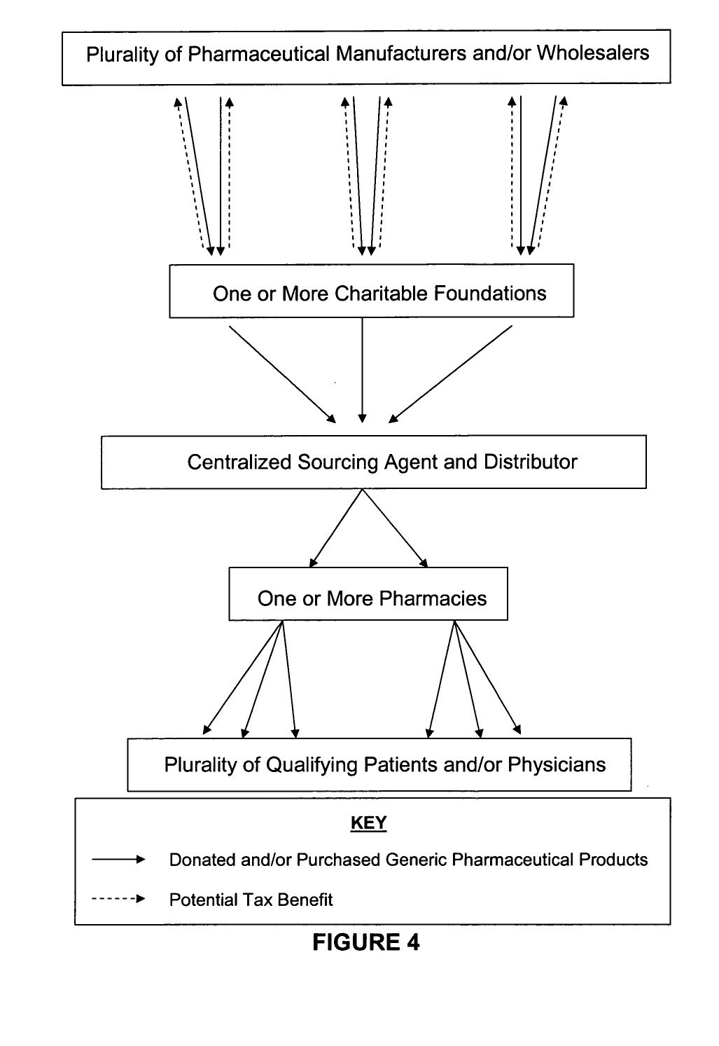

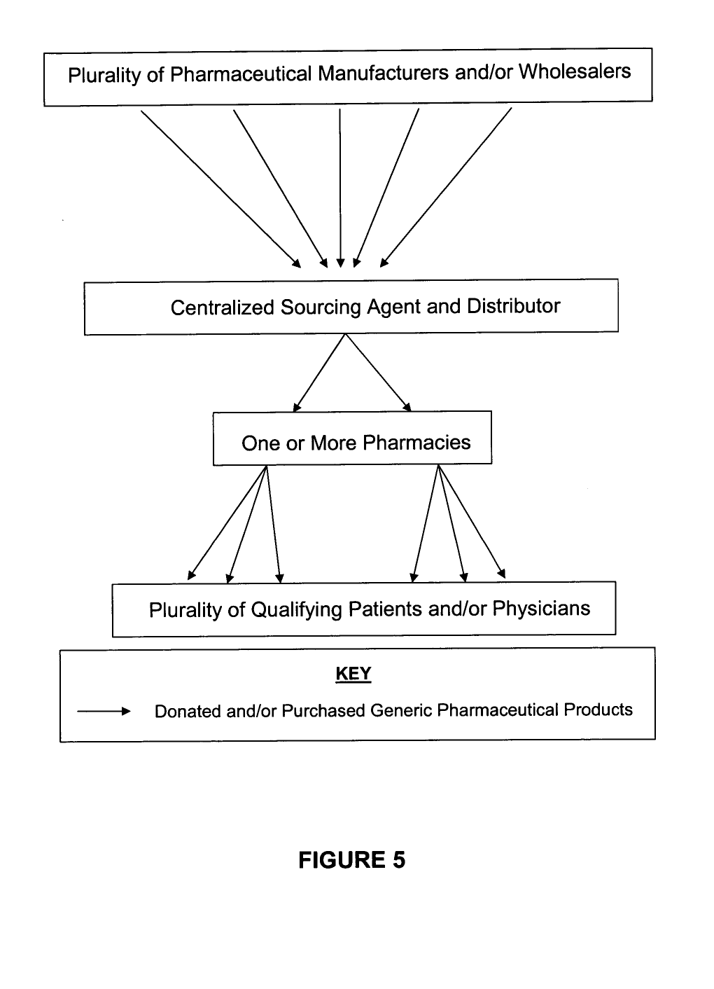

In a fourth embodiment, as shown in FIG. 4, one or more charitable foundations receive one or more generic pharmaceutical products from a plurality of sources. The one or more charitable foundations may then, preferably, transfer the received generic pharmaceutical products to a centralized sourcing agent and distributor. In accordance with the methods described herein, the transfer of generic pharmaceutical products from the plurality of sources to one or more charitable foundations and then to the centralized sourcing agent and distributor may occur by any number of ways including, for example, by sale or donation—as described above. The centralized sourcing agent and distributor may be responsible for compiling information provided by a plurality of patients, physicians and/or pharmacies. Using this information, the centralized sourcing agent and distributor may identify pharmacies that are interested in receiving the generic pharmaceutical products for redistribution to appropriate patients. The centralized sourcing agent and distributor then may, preferably, transfer the received generic pharmaceutical products to such pharmacies by way of sale or donation. The pharmacies then may, preferably, further dispense the generic pharmaceutical products to qualified patients or to physicians in accordance with the methods described above. If one or more sources of generic pharmaceutical products transfer such products to one or more charitable foundations by way of donation, of course, it may be entitled to a tax deduction or tax credit as described above. Alternatively, as shown in FIG. 5, the plurality of sources of generic pharmaceutical products may transfer such products directly to the centralized sourcing agent and distributor, which then may, preferably, dispense the received generic pharmaceutical products to appropriate pharmacies in accordance with the methods described herein.

The centralized sourcing agent and distributor of the present invention may be responsible for: (i) receiving generic pharmaceutical products from one or more charitable foundations, or, alternatively, receiving generic pharmaceutical products directly from manufacturers, wholesalers or any other source of generic pharmaceutical products; (ii) compiling information provided by a plurality of patients, physicians and/or pharmacies (directly or indirectly); (iii) using this information and substantially universal criteria, identifying patients that the centralized sourcing agent and distributor considers to be qualified to purchase the received generic pharmaceutical products at reduced prices; and/or (iv) dispensing the received generic pharmaceutical products to qualified patients, directly or indirectly, in accordance with a plurality of prescriptions issued by a plurality of licensed physicians; dispensing the donated generic pharmaceutical products directly to prescribing physicians and/or to pharmacies; and/or dispensing the received generic pharmaceutical products to one or more charitable foundations, which would later dispense such products to qualified patients, physicians and/or pharmacies. Additionally, the centralized sourcing agent and distributor may be responsible for continuously assessing the demand for specific generic pharmaceutical products among economically-challenged patients and identifying sources of generic pharmaceutical products that may be willing to sell or donate products to meet such demand.

The various steps outlined above, which comprise any of the embodiments described herein, may occur simultaneously. For example, a plurality of sources of generic pharmaceutical products may be transferring generic pharmaceutical products to one or more charitable foundations, while the centralized sourcing agent and distributor is compiling information from patients who are interested in purchasing the received generic pharmaceutical products at reduced prices. Likewise, one or more charitable foundations may receive generic pharmaceutical products from a plurality of sources, while the centralized sourcing agent and distributor is dispensing previously-received generic pharmaceutical products to qualified patients. The methods of the current invention, as described herein, and the steps thereof, are fluid and may occur incrementally or concurrently.

The many aspects and benefits of the invention are apparent from the detailed description, and thus, it is intended for the following claims to cover all such aspects and benefits of the invention which fall within the scope and spirit of the invention. In addition, because numerous modifications and variations will readily occur to those skilled in the art, the claims should not be construed to limit the invention to the exact construction and operation illustrated and described herein. Accordingly, all suitable modifications and equivalents should be understood to fall within the scope of the invention as claimed herein.

1. A method of dispensing generic pharmaceutical products, wherein the method comprises the steps of:
(i) a centralized sourcing agent and distributor receiving one or more generic pharmaceutical products from a plurality of sources;
(ii) said centralized sourcing agent and distributor compiling information provided by a plurality of prescribing physicians;
(iii) said centralized sourcing agent and distributor identifying physicians who are interested in receiving said generic pharmaceutical products for redistribution to patients; and
(iv) said centralized sourcing agent and distributor dispensing a plurality of said generic pharmaceutical products to the physicians identified in step (iii).

2. The method of dispensing generic pharmaceutical products according to claim 1, wherein at least one of said plurality of sources transfers generic pharmaceutical products to the centralized sourcing agent and distributor by way of donation.

3. The method of dispensing generic pharmaceutical products according to claim 1, wherein at least one of said plurality of sources transfers generic pharmaceutical products to the centralized sourcing agent and distributor by way of sale.

4. The method of dispensing generic pharmaceutical products according to claim 1, wherein said generic pharmaceutical products include short-dated products.

5. The method of dispensing generic pharmaceutical products according to claim 1, wherein said generic pharmaceutical products include returned products.

6. A method of dispensing generic pharmaceutical products to qualified patients, wherein the method comprises the steps of:
(i) a centralized sourcing agent and distributor receiving one or more generic pharmaceutical products from a plurality of sources;
(ii) said centralized sourcing agent and distributor compiling information provided by a plurality of patients;
(iii) from said information and using substantially universal criteria, said centralized sourcing agent and distributor identifying patients who are qualified to purchase said generic pharmaceutical products at reduced prices; and
(iv) said centralized sourcing agent and distributor dispensing a plurality of said generic pharmaceutical products to qualified patients.

7. The method of dispensing generic pharmaceutical products to qualified patients according to claim 6, wherein at least one of said plurality of sources transfers generic pharmaceutical products to the centralized sourcing agent and distributor by way of donation.

8. The method of dispensing generic pharmaceutical products to qualified patients according to claim 6, wherein at least one of said plurality of sources transfers generic pharmaceutical products to the centralized sourcing agent and distributor by way of sale.

9. The method of dispensing generic pharmaceutical products to qualified patients according to claim 6, wherein said generic pharmaceutical products include short-dated products.

10. The method of dispensing generic pharmaceutical products to qualified patients according to claim 6, wherein said generic pharmaceutical products include returned products.

11. The method of dispensing generic pharmaceutical products to qualified patients according to claim 6, wherein the centralized sourcing agent and distributor dispenses said generic pharmaceutical products directly to the preferred shipping address of each qualified patient.

12. The method of dispensing generic pharmaceutical products to qualified patients according to claim 6, wherein the centralized sourcing agent and distributor dispenses said generic pharmaceutical products to prescribing physicians, wherein said physicians further dispense said generic pharmaceutical products to the appropriate qualifying patients.

13. The method of dispensing generic pharmaceutical products to qualified patients according to claim 12, wherein the centralized sourcing agent and distributor also compiles information provided by said prescribing physicians, wherein such information provided by said prescribing physicians comprises each physician's name, business address, DEA number and the name of the prescribed generic pharmaceutical product.

14. A method of dispensing generic pharmaceutical products to qualified patients, wherein the method comprises the steps of:
(i) one or more charitable foundations receiving one or more generic pharmaceutical products from a plurality of sources;
(ii) said one or more charitable foundations transferring said generic pharmaceutical products to a centralized sourcing agent and distributor;
(iii) said centralized sourcing agent and distributor compiling information provided by a plurality of patients;
(iv) from said information and using substantially universal criteria, said centralized sourcing agent and distributor identifying patients who are qualified to purchase said generic pharmaceutical products at reduced prices; and
(v) said centralized sourcing agent and distributor dispensing said generic pharmaceutical products to qualified patients.

15. The method of dispensing generic pharmaceutical products to qualified patients according to claim 14, wherein said generic pharmaceutical products include short-dated products.

16. The method of dispensing generic pharmaceutical products to qualified patients according to claim 14, wherein said generic pharmaceutical products include returned products.

17. The method of dispensing generic pharmaceutical products to qualified patients according to claim 14, wherein the centralized sourcing agent and distributor dispenses said generic pharmaceutical products directly to the preferred shipping address of each qualified patient.

18. The method of dispensing generic pharmaceutical products to qualified patients according to claim 14, wherein the centralized sourcing agent and distributor dispenses said generic pharmaceutical products to prescribing physicians, wherein said physicians further dispense said generic pharmaceutical products to the appropriate qualifying patients.

19. The method of dispensing generic pharmaceutical products to qualified patients according to claim 18, wherein the centralized sourcing agent and distributor also compiles information provided by said prescribing physicians, wherein such information provided by said prescribing physicians comprises each physician's name, business address, DEA number and the name of the prescribed generic pharmaceutical product.

20. A method of dispensing generic pharmaceutical products, wherein the method comprises the steps of:
(i) a centralized sourcing agent and distributor receiving one or more generic pharmaceutical products from a plurality of sources;
(ii) said centralized sourcing agent and distributor compiling information provided by a plurality of prescribing physicians;
(iii) said centralized sourcing agent and distributor identifying physicians who are interested in receiving said generic pharmaceutical products for redistribution to patients;
(iv) said centralized sourcing agent and distributor transferring a plurality of said generic pharmaceutical products to one or more charitable foundations; and
(v) said one or more charitable foundations dispensing said generic pharmaceutical products to the physicians identified in step (iii).

21. A method of dispensing generic pharmaceutical products to qualified patients, wherein the method comprises the steps of:
(i) a centralized sourcing agent and distributor receiving one or more generic pharmaceutical products from a plurality of sources;
(ii) said centralized sourcing agent and distributor compiling information provided by a plurality of patients;
(iii) from said information and using substantially universal criteria, said centralized sourcing agent and distributor identifying patients who are qualified to purchase said generic pharmaceutical products at reduced prices;
(iv) said centralized sourcing agent and distributor transferring a plurality of said generic pharmaceutical products to one or more charitable foundations; and
(v) said one or more charitable foundations dispensing said generic pharmaceutical products to qualified patients.

22. The method of dispensing generic pharmaceutical products to qualified patients according to claim 21, wherein the one or more charitable foundations dispense said generic pharmaceutical products directly to the preferred shipping address of each qualified patient.

23. The method of dispensing generic pharmaceutical products to qualified patients according to claim 21, wherein the one or more charitable foundations dispense said generic pharmaceutical products to prescribing physicians, wherein said physicians further dispense said generic pharmaceutical products to the appropriate qualifying patients.

24. A method of dispensing generic pharmaceutical products, wherein the method comprises the steps of:
(i) a centralized sourcing agent and distributor receiving one or more generic pharmaceutical products from a plurality of sources;
(ii) said centralized sourcing agent and distributor compiling information provided by a plurality of patients and physicians;
(iii) said centralized sourcing agent and distributor identifying pharmacies that are interested in receiving said generic pharmaceutical products for redistribution to patients; and
(iv) said centralized sourcing agent and distributor dispensing a plurality of said generic pharmaceutical products to the pharmacies identified in step (iii).

25. A method of dispensing generic pharmaceutical products, wherein the method comprises the steps of:
(i) a centralized sourcing agent and distributor receiving one or more generic pharmaceutical products from one or more charitable foundations;
(ii) said centralized sourcing agent and distributor compiling information provided by a plurality of patients and physicians;
(iii) said centralized sourcing agent and distributor identifying pharmacies that are interested in receiving said generic pharmaceutical products for redistribution to patients; and
(iv) said centralized sourcing agent and distributor dispensing a plurality of said generic pharmaceutical products to the pharmacies identified in step (iii).
